(19) United States
(12) Patent Application Publication
(10) Pub. No.: US 2026/0167830 A1
(43) Pub. Date: Jun. 18, 2026

(54) CORROSION-INHIBITING COATINGS FOR METAL MESH GASKETS AND METALLIC PARTICLES

(71) Applicant: The Patent Well LLC, Fort Worth, TX (US)

(72) Inventors: Ryan Merritt, Grapevine, TX (US); Kent Boomer, Aledo, TX (US); Mike Dry, Fort Worth, TX (US); Peter Sibello, Benbrook, TX (US); Matt Boyd, Fort Worth, TX (US)

(21) Appl. No.: 19/358,221

(22) Filed: Oct. 14, 2025

Related U.S. Application Data
(62) Division of application No. 17/655,298, filed on Mar. 17, 2022, now abandoned.
(60) Provisional application No. 63/200,613, filed on Mar. 18, 2021.

(51) Int. Cl. C09D 5/08; C09C 1/00; C09C 3/06; C23C 22/42

(52) U.S. Cl. CPC C09D 5/084; C09C 1/003; C09C 3/063; C23C 22/42

(57) ABSTRACT

A molybdate solution is disclosed from which molybdate oxide coatings may be derived on metal particles or metal mesh. The coated metal particles may then be combined with a film forming binder and, optionally, corrosion inhibitors to make a corrosion composition. The coated metal mesh may then be used in making gaskets that inhibit corrosion.

### CROSS-REFERENCE TO RELATED APPLICATION

This application is a divisional of copending U.S. patent application Ser. No. 17/655,298 filed Mar. 17, 2022, and claims the benefit of U.S. Provisional Patent Application No. 63/200,613 Mar. 18, 2021, each of which is hereby incorporated.

### BACKGROUND OF THE INVENTION

### Field of the Invention

Metallic particles and metal mesh skeletons with a coating derived from a molybdate solution. The coated metal particles are for use with binders and, optionally, corrosion inhibitors to provide a corrosion-inhibiting film forming composition for use on metallic substrate. The metal mesh is for use in a gasket that inhibits corrosion.

### Description of the Related Art

For decades uncoated metal particles have been added to paint to inhibit corrosion, including galvanic corrosion, the particles acting as sacrificial electrodes when the paint is used to protect a metal substrate, which substrate may be exposed to sea water, for example. Magnesium, zinc, and aluminum (including aluminum alloy) are three such metal particles. More recently, it was discovered that coating aluminum alloy particles with a semi-conducting corrosion inhibiting coating provides superior protection when used in paints, coating, in turn, a metal surface (see U.S. Pat. No. 8,277,688 for example). Such coated aluminum alloy particles act as sacrificial anodes but the coating on the particles inhibits self-corrosion of the particles.

There are effective aluminum coated powders for use in film forming compositions available, such as the tri-chromium based corrosion inhibiting coating, see U.S. Pat. Nos. 8,277,688, 9,243,150, 9,243,333 and 9,534,120, all of which are incorporated herein by reference. These applications disclose an aluminum alloy powder coated with a tri-chromium (Cr⁺³) based aqueous coating solution, combined with a binder (such as a paint binder) for use as a film forming composition applied to aluminum and other metal substrates to protect against corrosion. These patent publications are sometimes referred to herein as the “Navy” patents.

The aqueous solution from which such unique particles are derived is, generally, a trivalent chromium compound and a hexafluorozirconate, with either specific fluorocarbons (tetra or hexa) and/or divalent zinc (see Navy U.S. Pat. No. 8,277,688). The pH is adjusted to 2.5 to 5.5. Corrosion inhibitors, such as inorganic or organic water-soluble corrosion inhibitors may be added.

The aluminum alloy particles of the prior art were processed in an N₂/H₂, oxygen, or nitrogen/inert gas atmosphere and provided in 2-100 micron sizes, longest dimension. The coating on the particles is very thin, nanometer scale. It reduces self-corrosion and improves adhesion to binders.

The prior art coated aluminum alloy particles were added at 20-80 parts to 5-80 parts of a film forming binder. Up to 10 parts of an ionic corrosion inhibitor, up to 5 parts wetting agent, up to 5 parts water soluble organic corrosion inhibitor, and up to 5 parts solvent are optional.

In Navy U.S. Pat. No. 9,243,333, the aqueous solution is modified to replace the fluorocarbons with fluorometallate and additional and different corrosion inhibitors are disclosed. In addition, different aluminum alloys are disclosed, with the general formula of Al—X—Y, with X and Y being alloying elements selected from specific groups.

The prior art tri-chromium based solution from which the particle coating is derived takes seven days to equilibrate before mixing in the particles. The coated particles resulting, when added to binders with, optionally, ionic or organic corrosion inhibitors, provide a very effective corrosion inhibiting film when applied to metals.

Prior art metal meshes have been coated with conversion coatings derived from Cr⁺³ solutions, see U.S. Pat. No. 10,837,555.

### SUMMARY OF THE INVENTION

The present invention in at least one embodiment is generally directed to a chromium free, molybdate-based aluminum alloy reactive liquid aqueous solution leaving oxidation reaction products on aluminum particles which in turn are combined with binders such as binders used for paint. Optionally, organic or ionic based or other corrosion inhibitors may also be added. The result is a film forming composition that is used to help prevent corrosion of metallic substrates, in part due to the coated alloy particles acting as sacrificial anodes.

A molybdate based coating, used for coating metal particles including aluminum alloy particles and coating metal mesh, in some embodiments is prepared from an aqueous solution comprising a molybdate, a permanganate and a hexafluorozirconate, adjusted to a pH range of 0-14, and applied to the particles or the mesh to form an electrically conductive or semi-conductive corrosion preventative coating (typically about 1 nanometer—5 micron thick). The coated particles, in some embodiments, for use with a binder to form a paint or other corrosion inhibiting film forming composition. The coated metal mesh may be used in a gasket.

In some embodiments the molybdate of the aqueous solution is a potassium molybdate (K₂MoO₄), the permanganate is potassium permanganate (KMnO₄), and the hexafluorozirconate is potassium hexafluorozirconate (K₂ZF₆). These components molar range is in some embodiments from 0.001-0.50 moles per liter for each. In some embodiments the pH of the aqueous solution may be adjusted with potassium hydroxide or sulfuric acid to be basic or acidic with a pH in the range of 0-14. To increase surface growth and reaction efficiency, an ionic barium or boron salt may be added, to act as a pH buffer. The solution deposits a semi-conducting corrosion inhibiting molybdate oxide based coating onto the metal mesh or the aluminum alloy particles and reduces or eliminates particle self-corrosion when the coated particles are added to a binder and applied to metal substrate such as aluminum alloy and exposed to salt fog.

In preferred embodiments potassium permanganate may be used to help provide a colorant and act as a corrosion inhibitor. In some embodiments the aqueous molybdate/permanganate solution may be acidic, in the range of 2-5. The pH may be adjusted with sulfuric acid or other suitable acid.

In some embodiments the molybdate based coating is applied to aluminum alloy particles, including aluminum alloy of 2000, 3000, 5000 and 7000 series to provide, when incorporated into a binder, a film forming composition providing effective corrosion resistance and some electrical conductivity, especially when applied to metallic substrate.

In accordance with some aspects of the present invention there is provided an aqueous treatment or coating solution which contains as ingredients at least potassium molybdate, a permanganate fluorozirconate (such as potassium hexafluorozirconate) with a pH of 0-14, and, preferably, free of lithium and chromium. In some embodiment's pH may be adjusted to 2-4 with sulfuric acid or other reagent. In some embodiments the pH nay be adjusted to 9-11 with potassium hydroxide or other reagent. The components are added as powder to deionized water at room temperature in the molar ranges indicated and mixed for typically 2-15 minutes, until dissolved. After mixing, any of the molybdate solutions disclosed herein are immediately ready to receive the uncoated particles or uncoated metal mesh, there is no need to let stand and equilibrate.

In some embodiments the particles having the molybdate solution derived coating set forth herein are used in place of the tri-chromium compound based coated particles used in the prior art, including the Navy patents incorporated herein by reference. Indeed, the molybdate coated particles may be used as a substitute for any chromium-based coated particles in a film forming composition.

The aqueous solution from which the particles are derived may be used to coat a metal mesh with an electrically semi-conductive, corrosion inhibiting coating which coated metal mesh may then be used in a gasket.

The above as well as additional objectives, features, and advantages in the various embodiments of the present invention will become apparent in the following detailed written description.

### BRIEF DESCRIPTION OF THE DRAWINGS

The present invention may be better understood, and its numerous objects, features, and advantages of its various embodiments made apparent to those skilled in the art by referencing the accompanying drawings.

FIG. 1A is an illustration of a cross section coated particle in accordance with one implementation of the present invention;

FIG. 1B is a partial view of a coated metal mesh in cross section in accordance with one implementation of the present invention;

FIG. 2A is a schematic representation of the film forming composition in accordance with one implementation of the present invention;

FIG. 2B illustrates a molybdate solution containing reservoir in accordance with one implementation of the present invention;

FIG. 3 is a block drawing of the coating process in accordance with one implementation of the present invention; and

FIG. 4 is a gasket made with the coated metal mesh in accordance with one implementation of the present invention.

The use of the same reference symbols in different drawings indicates similar or identical items.

### DESCRIPTION OF THE PREFERRED EMBODIMENT(S)

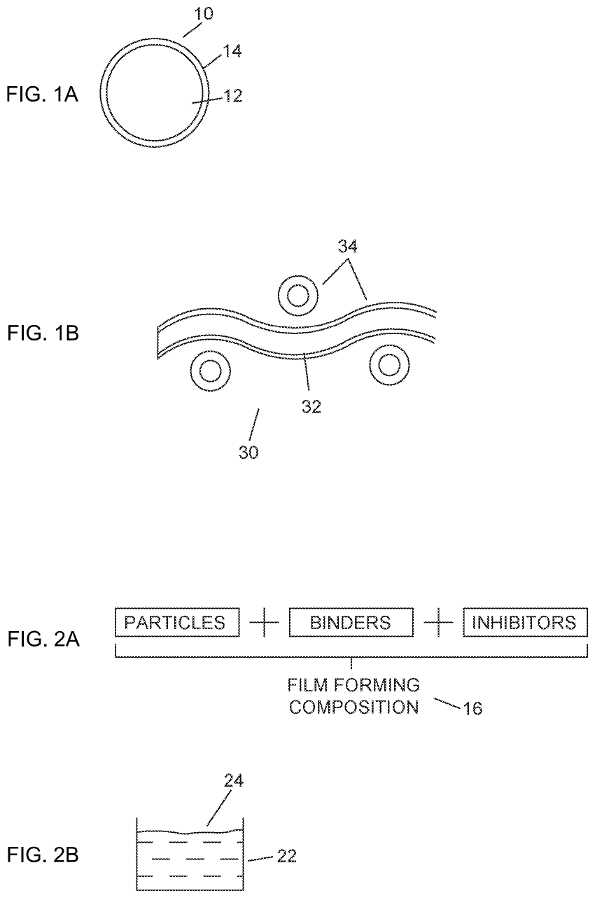

FIG. 1A illustrates a coated aluminum alloy particle 10 comprising an aluminum alloy particle 12 which may be, in some embodiments, 1-200 microns in longest dimension, with a molybdate oxide coating 14 (in the nanometer to micron range) derived from the molybdate solutions disclosed herein. The particles may be spherical, granular, or flake-like and are typically prepared in an oxygen, nitrogen/inert gas or H2 /N2 atmosphere. They may be obtained from Valimet, Inc., Stockton, California.

FIG. 1B illustrates a partial view of a coated metal mesh 30 made up of multiple woven metal strands 32 having a thin molybdate solution derived, semi-conductive corrosion inhibiting coating 34.

FIG. 2A illustrates the general composition of a film forming composition 16 comprised of the coated aluminum alloy particles 10 set forth herein, mixed with binders including, in some embodiments, binders to which a curing agent is added and, optionally, corrosion inhibitors, including, without limit, organic based and ionic corrosion inhibitors.

FIG. 2B illustrates a reservoir or container 22 in which the aqueous molybdate coating solution 24 is placed and which may receive the untreated metallic particle 12, in some embodiments aluminum, aluminum alloy, or any other metallic particles, or the uncoated metal mesh skeleton.

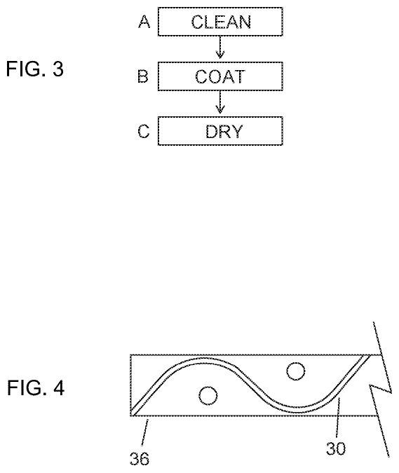

FIG. 3 illustrates a general process for an aluminum particle, step A (optional) comprising cleaning and step B the application of the molybdate based coating by soaking untreated particles 12 in molybdate solution 24. In some embodiments the uncoated particles may be added at 200 grams (range 100-300 gram) per liter of molybdate solution. Step C is the drying of the coated particles. These steps, generally, may be found in Navy U.S. Pat. No. 9,243,333.

The binders for the film forming composition may be paint, oils, greases, epoxy polymers, polyurethanes, polysiloxanes, lubricants, sealants, or the like. In some embodiments the binders may comprise 50-95% of the non-volatile weight of the film forming composition, 10-70% coated particles and 0.0 to 40% corrosion inhibitors.

The binders may include a film forming resin and curing agent for the film forming resin. The film forming resin may be selected from the group comprising: epoxy resins, polyesters, polyacrylates, polyurethanes, polyethers, polyaspartic esters, polysiloxanes, isocyanates, mercapto-functional resins, amine-functional resins, amide-functional resins, imide-functional resin, silane-containing resins, polysiloxanes, acetoacetate resins, functional fluorinated resins, alkyd resins, and mixtures thereof.

The binders may include those set forth in Navy U.S. Pat. No. 9,243,333 including urethane and epoxy binders, and binders with curing agents and binders that do not have curing agents, including those that moisture cure. Some binders are polymers derived from epoxies, isocyanates, acrylics, and the incurred polymers or precursors of the polymers including polyimides and the precursors, i.e. polyamic acids. Various polyfunctional aromatic amines may be used to prepare the polyimide precursors or polymers. Other known polymer binders include epoxies or epoxy resins or the precursors and polymer binders derived from isocyanates. Binders, including epoxy precursors, include those that are liquid at room temperature. Examples of other binders include polyacrylates and water-soluble acrylic latex emulsion coatings. The physical properties of the film, such as strength, flexibility, chemical resistance and solvent resistance can be controlled over a wide range by selecting proper polyols and adjusting NCO to OH ratio. Inorganic binders may also be used, see L. Smith, et al, “Generic Coating Types: An Introduction to Industrial Maintenance Coating Materials”, Pittsburgh, Pennsylvania, incorporated herein by reference, and Navy U.S. Pat. No. 9,243,333.

Lithium salts have been shown to be suitable corrosion inhibitors for binders and include the following as set out in U.S. Pat. No. 8,628,689 (Visser, et al) incorporated herein by reference, lithium phosphate and lithium carbonate. Visser discloses, in some embodiments, a coating composition curable below 120° C. comprising a film-forming resin, a curing agent for the film-forming resin, and a lithium salt, wherein the lithium salt is selected from inorganic and organic lithium salts that have a solubility constant in water at 25° C. in the range of 1×10−11 to 5×10⁻². The lithium salt may be selected from the group consisting of lithium carbonate, lithium phosphate, and mixtures thereof. Other lithium salt combinations, with synergetic polycarboxylate may be found in another Navy patent, U.S. Pat. No. 10,889,723 incorporated herein by reference. These include synergistic corrosion-resistant inhibitor compositions consisting essentially of combinations of at least one metal polycarboxylate and 1 to 50 percent by weight of the composition of lithium phosphate wherein the metal of the polycarboxylate is selected from the group consisting of Groups Ib, IIa, IIb, IIIa, IIIb, IVb, Vb, VIb and VIII of the periodic table. These inhibitors may be combined with other components of the film forming composition, in some embodiments in the amount 1-40% by volume of the total non-volatile components of the film forming compound.

In some embodiments the film forming composition may contain corrosion inhibitors that contain magnesium, including: a magnesium-containing material from the group consisting of magnesium metal particles (1-15 micron in size), magnesium alloy, magnesium oxide, oxyaminophosphate salts of magnesium, magnesium carbonate, and magnesium hydroxide.

In some embodiments the film forming composition is characterized by the absence of lithium. In some embodiments, the lithium free corrosion inhibitors include those set forth in another Navy patent, U.S. Pat. No. 10,351,715 incorporated herein by reference, including polycarboxylate acids and a variety of cations. Certain specific combinations of certain metal polycarboxylate salts have synergistically proven especially effective, in loading ranges of 0.1 up to 30 weight percent of binder non-volatile weight, or . 01% to 30% of the total weight of the film forming composition.

This range may be used for any of the corrosion inhibitors disclosed herein. These lithium-free synergistic corrosion inhibiting combinations may include: at least one metal polycarboxylate derived from a stoichiometric reaction of metal compounds and polycarboxylate acids to obtain polycarboxylic metal salts, and at least one metal carboxylate derived from the stoichiometric reaction of metal compounds and polycarboxylic acids to obtain polycarboxylic metal salts, wherein either the metal or the carboxylic acid in at least one of the carboxylic metal salts is different from the other carboxylic metal salt.

Five such lithium free synergistic combinations include: all 0.1 to 20 parts by weight of each of the pair: magnesium oxalate and zinc oxalate, zinc oxalate and zinc citrate, zinc oxalate and zinc succinate, zinc tartrate and zinc citrate, and zinc adipate and zinc citrate. Note that any of the aforementioned may, optionally, include lithium salts as set forth herein.

In preparation for examples 1A and 1B, about 200 grams (range 100-300 grams) of spherical 10 micron uncoated aluminum alloy particles are added to 1 liter of molybdate solution (with pH adjusted to 3) at room temperature and agitated or stirred for 3-10 minutes. The solution is decanted off and the wet powder is rinsed 3 times with deionized water. The damp brick is air dried at room temperature 24-48 hours (alternatively it may be dried with a polar organic solvent such as acetone which may then be drawn off with a vacuum, or oven dried at 63° C. for 12-36 hours).

A metal oxide coating on the particles results, free of lithium and chromium. This semi-conductive coating will prevent oxidation on the surface of the particles (which would act as an insulator) thus allowing the particles to act as sacrificial anodes when used in a film forming composition, which is applied to a metal.

In example 1A, 5 pounds of coated particles were added to 3 pounds of epoxy binder, to which 3 pounds of powder zinc metal carboxylates as corrosion inhibitors were added and mixed.

In example 1B, 5 pounds of coated particles were added to 3 pounds of polysiloxane binder, to which 3 pounds of powder zinc metal carboxylates as corrosion inhibitors were added and mixed until fully dispersed.

The film forming compound of example 1A and 1B were applied to aluminum alloy (2024 T-3) test coupons and tested salt fog per ASTM B117. These and other standard corrosion tests show results comparable to Cr⁺³ power bearing corrosion inhibiting film forming compositions of the prior art.

Additional examples of combinations of binders, corrosion inhibitors, and the molybdate coated particles as set forth herein will improve corrosion resistance of binder-only compositions when applied to metal substrates.

In some embodiments the molybdate solution treated articles on which conversion coatings set forth herein are used are aluminum alloy metal mesh skeletons 30 (see FIG. 1B), in gaskets 36 (see FIG. 4) and in the manner and methods as set forth in Applicant's U.S. Pat. No. 10,837,555 incorporated herein by reference.

As seen in FIG. 1B, molybdate conversion coating 34 provides both corrosion protection and electrical conductivity (low resistance) to the coated metal mesh 30, used in aircraft antenna gaskets or other gaskets 36, see FIG. 4. If one aircraft part is a ground plane, the coated gasket may provide a ground to the other aircraft part. In some embodiments the molybdate coating on the alloy mesh or metallic particle is between 1 nanometer and 5 mil thick and provides less than about 2.5 milliohms of resistance under 100 to 2,000 psi, even after 500 hours testing (ASTM B117).

FIG. 3 illustrates a general passivation process for uncoated aluminum or stainless steel metal mesh, cleaning (optional), for example, by degreasing, acid etching and rinsing. The mesh may be soaked in molybdate solution 24 for 5 to 10 minutes at room temperature until an even coat is observed (usually with a slight color change), avoid over-coating (rough surface), then removed, rinsed in deionized water and air dried. Alternately, the coated mesh can be dipped in acetone to speed up drying.

The metal mesh to be coated may be aluminum, including aluminum alloy, or steel, including stainless steel. Aluminum alloys that are suitable include 2000, 5000, 6000 and 7000 series alloys. In one embodiment, the metal mesh is one of AL 6061, 2024, 5056, or 7075 woven mesh, such as 40 strands per inch (Cleveland wire cloth).

Salt fog testing at 500 hours and visual inspections shows improved corrosion resistance (tested between 7075 and 6061 against alodine coated coupons, without polymer).

In the preceding description, for purposes of explanation, numerous details are set forth in order to provide a thorough understanding of the embodiments. However, it will be apparent to one skilled in the art that these specific details are not required. In other instances, well-known structures and components are shown in block diagram form in order not to obscure the understanding.

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. It is therefore contemplated that such modifications can be made without departing from the spirit or scope of the present invention as defined in the appended claims.

What is claimed is:

1. Coated metal particles, wherein the coating is derived from a molybdate solution, the molybdate solution reactive to metal particles in an uncoated state.

2. The coated metal particles of claim 1, wherein the metal is aluminum or an alloy thereof.

3. The coated particles of claim 1, wherein the coating is electrically conductive or semi-conductive.

4. The coated particles of claim 2, wherein the molybdate solution includes a molybdate and at least one of a permanganate and a hexafluorozirconate.

5. The coated particles of claim 4, wherein the molybdate, permanganate and hexafluorozirconate are selected from the group comprising: potassium molybdate, potassium permanganate and potassium hexafluorozirconate.

6. The coated particles of claim 5, wherein the molybdate solution is an aqueous solution.

7. The coated particles of claim 4, wherein each of the molybdate, permanganate and hexofluorozirconate components present in the molybdate solution is present in the molar range from 0.001-0.50 moles per liter of the molybdate solution.

8. The coated particles of claim 4, wherein the coating has a thickness of between 1 nanometer and 5 micron.

9. The coated particles of claim 4, wherein individual particles of the particles have a size of between 1 and 200 microns in the longest dimension of the particle.

10. The coated particles of claim 9, wherein individual particles of the particles are spherical, granular or flake-like in shape.

11. The coated particles of claim 9, wherein the molybdate solution is an aqueous solution and includes a pH adjuster and/or a buffer.

12. The coated particles of claim 11, wherein the pH of the molybdate solution is adjusted to between 2 and 4 or between 9 and 11.

13. The coated particles of claim 9, wherein the coating is free of one or more of: chromium and lithium.

14. A method of manufacturing the coated particles of claim 1, comprising the steps of:
mixing the molybdate solution;
adding the metal particles to the mixed molybdate solution.

15. The method of claim 14, wherein the mixed molybdate solution is capable of receiving the metal particles immediately post mixing of said molybdate solution.

16. The method of claim 14, further including at least one of the following steps:
cleaning the metal particles prior to adding said metal particles to the mixed molybdate solution;
agitating or stirring the mixture of metal particles and molybdate solution for a period of time;
decanting off the molybdate solution;
rinsing the wet coated particles; and
drying the coated particles.

17. The method of claim 16, wherein the metal particles are aluminum or an alloy thereof.

18. The method of claim 17, wherein the step of mixing the molybdate solution comprises the steps of:
providing a quantity of deionized water;
adding in powder form components of the molybdate solution to the deionised water; and
mixing the powder form components of the molybdate solution with the deionized water.

19. The method of claim 18, wherein the powder form components are selected from the group comprising: potassium molybdate, potassium permanganate and potassium hexofluorozirconate.

20. A corrosion-resistant composition for application to metal substrates comprising:
the coated metal particles of claim 1; and
a binder.

21. The corrosion-resistant composition of claim 20, wherein the binder is a film forming binder.

22. The corrosion-resistant composition of claim 21, wherein the binder includes a curing agent.

23. The corrosion-resistant composition of claim 21, wherein the composition further comprises a corrosion inhibitor.

24. The corrosion-resistant composition of claim 23, wherein the corrosion inhibitor is ionic or organic.

25. The corrosion resistant composition of claim 23, wherein the film forming binder is selected from the group comprising: paints, oils, greases, polymers, epoxy polymers, polysiloxanes, polyurethanes, lubricants, epoxies, epoxy precursors, isocyanates, acrylics, polymer precursors, polymeric acids, poly functional aromatic amines, polyacrylates, water-soluble acrylic latex emulsion and sealants.

26. The corrosion resistant composition of claim 23, including at least one corrosion inhibitor selected from the group comprising: a lithium salt, an organic or inorganic lithium salt, lithium phosphate, lithium carbonate, at least one metal polycarboxylate, magnesium containing materials, magnesium metal particles, magnesium alloy, magnesium oxide, oxyaminophosphate salts of magnesium, magnesium carbonate and magnesium hydroxide, magnesium citrate, magnesium oxalate, zinc citrate, zinc oxalate, and a combination thereof.

27. The corrosion resistance composition of claim 23, wherein the corrosion inhibitor is lithium free.

28. The corrosion resistant composition of claim 23, wherein the corrosion inhibitor comprises lithium free synergistic combinations of metal oxalates, metal pirates, metal succinate, metal tartrates and metal adipate.

29. The corrosion resistant composition of claim 23, comprising by non-volatile weight of the film forming composition:
50-95% binder;
10-70% coated particles; and
0.0-40% corrosion inhibitor.
